(19) United States
(12) Patent Application Publication
(10) Pub. No.: US 2013/0047799 A1
(43) Pub. Date: Feb. 28, 2013

(54) APPARATUS FOR PRODUCING A PRECISE TIGHTENING TORQUE FOR SCREW CONNECTIONS

(71) Applicant: Marc Gareis, Leonberg (DE)

(72) Inventor: Marc Gareis, Leonberg (DE)

(73) Assignee: LOESOMAT SCHRAUBTECHNIK NEEF GMBH, Vaihingen/Enz (DE)

(21) Appl. No.: 13/695,857

(22) PCT Filed: May 3, 2011
(86) PCT No.: PCT/DE2011/001020

§ 371 Date: Nov. 2, 2012

(30) Foreign Application Priority Data
May 6, 2010 (DE) 10 2010 019 792.0

(51) Int. Cl. B25B 23/142; G01L 25/00

(52) U.S. Cl. 81/467; 73/1.12

(57) ABSTRACT

The invention relates to a device for producing precise tightening torque for screw connections including the combination of a torque multiplier (100) and a torque wrench (200) which is adapted to the torque multiplier and calibrated therewith. The invention also relates to a method for calibrating the type of device.

The invention relates to an apparatus for producing a precise tightening torque for screw connections according to the preamble of claim 1 and a method for calibrating such an apparatus according to the preamble of claim 6.

Torque multipliers, which will also be referred to below as power multipliers, generally comprise a high-transmission planetary gear. Spur gears or epicycloidal gears are also sometimes used in torque multipliers. The input torque is set manually and is mostly produced by means of a ratchet or torque wrench. The output torque of the gear can then be determined on the basis of a gear ratio which was determined beforehand, is known and is stored in a table for example. The gear efficiency is not taken into account however. Alternatively, the output torque is taken from a torque setting table which was also previously determined. In this case, the gear efficiency will be taken into account, with interpolation being performed in the case of intermediate values.

Within the scope of quality control with manual torque or power multipliers, it is desirable to check and document the applied torque values by spot checks.

Different apparatuses and methods are known for detecting the torque for this purpose. A first solution known from the state of the art provides integrating a torque sensor in the gear of the power multiplier. The sensor needs to be supplied in this case with power via an external evaluation device which was also known as a data logger. The data are recorded and stored in said data logger.

Another solution known from the state of the art provides a torque sensor which is switched in series with the power multiplier. A suitable torque sensor is arranged on the output shaft of the gear. The power supply and data recording occur in this case too by means of a cable-bound external device.

In both solutions known from the state of the art, power supply of the sensor and data evaluation and storage occur on the outside or from the outside. For this purpose, electric lines in form of cables and evaluation devices are required which will be subjected to rough conditions at the construction site. The sensitive exposed cables are frequently inadvertently torn off or damaged. Plug-in connections are also provided which can be damaged or bent off in contact with other components. So-called interface sockets which contain plug connections for the cables and are arranged on the gear housing as additional housings which are usually cuboid and protrude beyond the gear housing can be damaged. It is also disadvantageous that the required evaluation devices need to be hung around the neck by the operator in addition to the other devices or be carried in form of belt bags or the like. Data transmission between the sensors and the evaluation device mostly occurs by way of “flying” cables which additionally obstruct the operator.

The invention is therefore based on the object of providing an apparatus which allows use by the operator without any limitations by cables or external devices, and additionally ensures the highest possible security in determining the output torque.

This object is achieved by an apparatus for producing precise tightening torque of the kind mentioned above by a torque multiplier and an electronic torque wrench which is adjusted to said torque multiplier, calibrated together with said torque multiplier and displays the torque.

Advantageous further developments and embodiments of the apparatus in accordance with the invention are the subject matter of the dependent claims referring back to claim 1.

Accordingly, an advantageous further development of the apparatus in accordance with the invention provides that the electronic torque wrench comprises a display for displaying the initially described output torque, wherein the input and output torque refer to the gear.

The torque wrench comprises in a very advantageous manner an input device for the input of torque limit values.

Preferably, the torque wrench further comprises a storage device for storing the data characterizing the torque of the screw connection. The storage device comprises a read-write memory, so that the calibrations can be repeated and performed again if required.

In addition to other data, the gear ratio of the torque multiplier which is determined during calibration is also stored in the memory in addition to other data.

The gear ratio is preferably stored in the memory as an interpolation curve of the functional connection of the output torque depending on the input torque of the torque multiplier.

An especially advantageous embodiment provides that the gear comprises an RFID transponder and the torque wrench an RFID reader which are adjusted to each other. In this case, the torque wrench recognizes the gear. Data that are stored in the memory and characterize the gear can be used for determining the tightening torque of the screw connections.

The invention is further based on the object of providing a method which simply enables a common calibration of torque multipliers and electronic torque wrenches, wherein specific data of the torque multiplier and its gear in particular shall be taken into account in the calibration.

This object is achieved by a method for calibrating an apparatus for producing a precise tightening torque for screw connections with the features of claim 6. The common calibration of the torque multiplier together with the electronic torque wrench occurs in such a way that the gear ratio occurs on the basis of at least one average value gained over the entire torque range. This gear ratio determined in this manner will be stored in the memory of the torque wrench and will be considered in the determination of the torque of the screw connection during later screwing processes.

Advantageous embodiments of the method are the subject matter of the dependent claims referring back to claim 6. Accordingly, in accordance with an advantageous embodiment the actual gear ratio will be determined and stored over the entire torque range at different angular positions of the output shaft of the torque multiplier. For this purpose, the gear ratio will be determined and stored at first over the entire torque range at a first angle, whereafter the output shaft will be further rotated about a predeterminable angle, and the gear ratio will be determined and stored in these respective angular positions over the entire torque range.

Preferably, the output shaft will further be rotated by a respective angle of 90° until it has been twisted in total about an angle of 180°. Said further rotation about a predeterminable angle is based on the realization that the torque progression of the output torque shows a substantially periodic progression depending on the input torque, which periodic progression can be described by a sine or cosine function. Further rotation about a respective multiple of 90° allows determining this periodic sine/cosine progression. If rotation occurs about small angles than 90° (e.g. about 45°), rotation needs to be continued with such a frequency until a rotation of the output shaft of the torque multiplier about 180° has occurred. A mean gear ratio is thereafter calculated from the values thus obtained, and stored in the memory of the electronic torque wrench. In this process, an interpolation curve, and a straight interpolation line in a first approximation, is placed between the gear ratios determined in this manner under different angular ratios and, on the basis of this interpolation curve, the output torque is determined depending on the input torque.

Embodiments of the invention are shown in the drawings and are explained in closer detail in the description below, wherein:

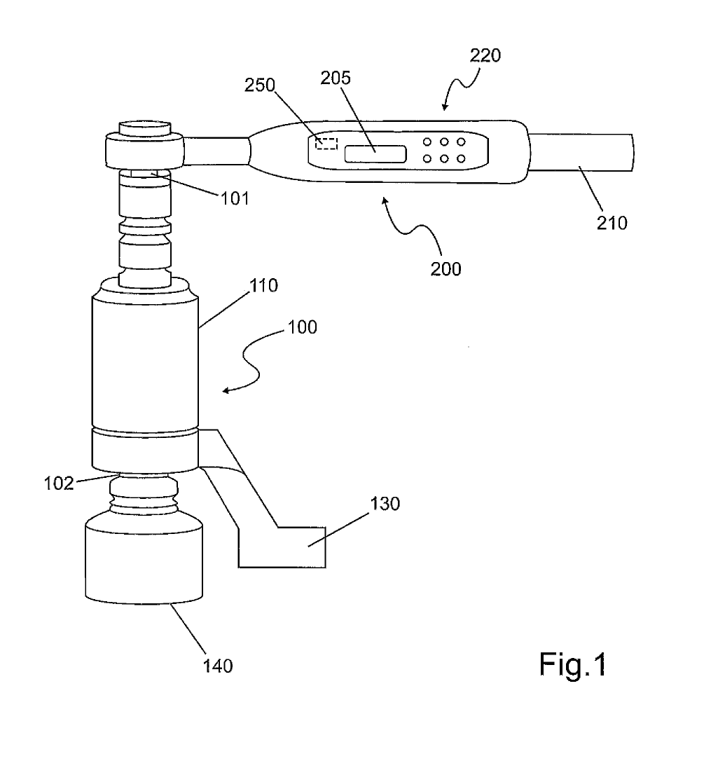

FIG. 1 schematically shows an apparatus that makes use of the invention for producing a precise tightening torque for screw connections;

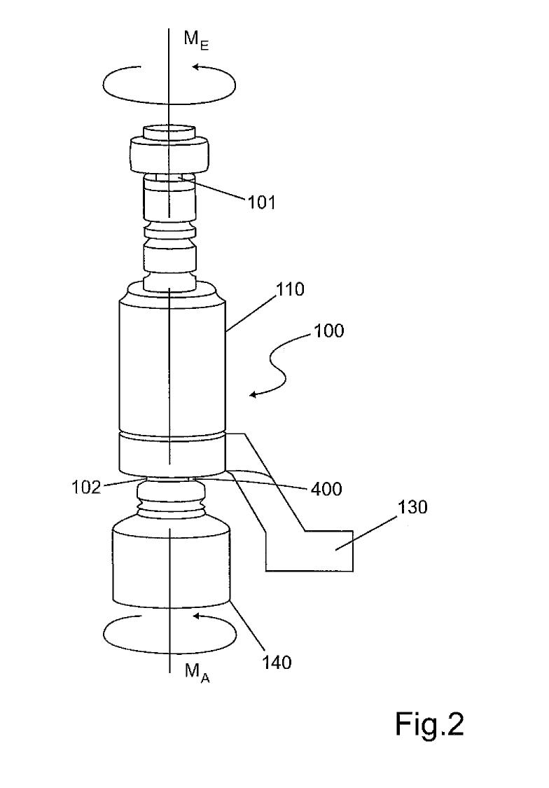

FIG. 2 shows the torque multiplier of the apparatus as shown in FIG. 1;

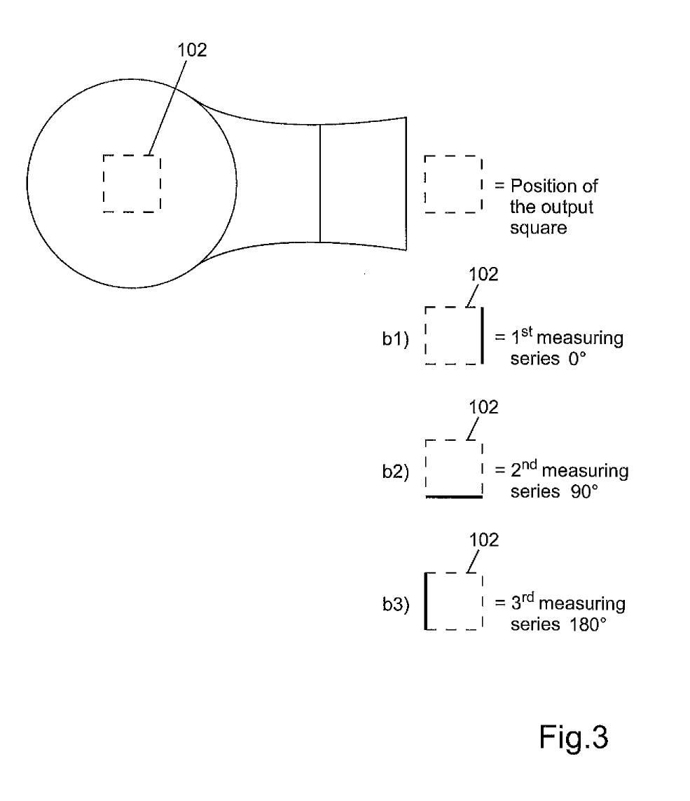

FIG. 3 shows a top view of the torque multiplier as shown in FIG. 2;

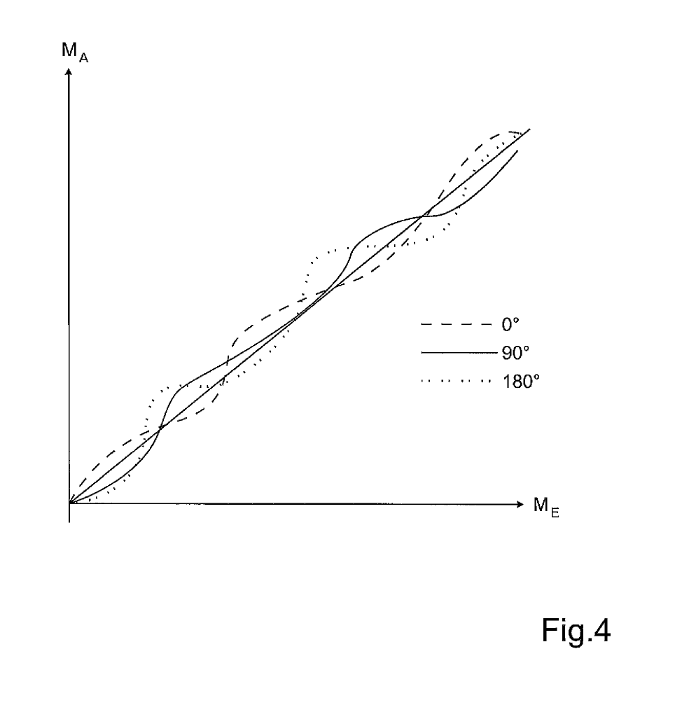

FIG. 4 shows the output torque over the input torque, and

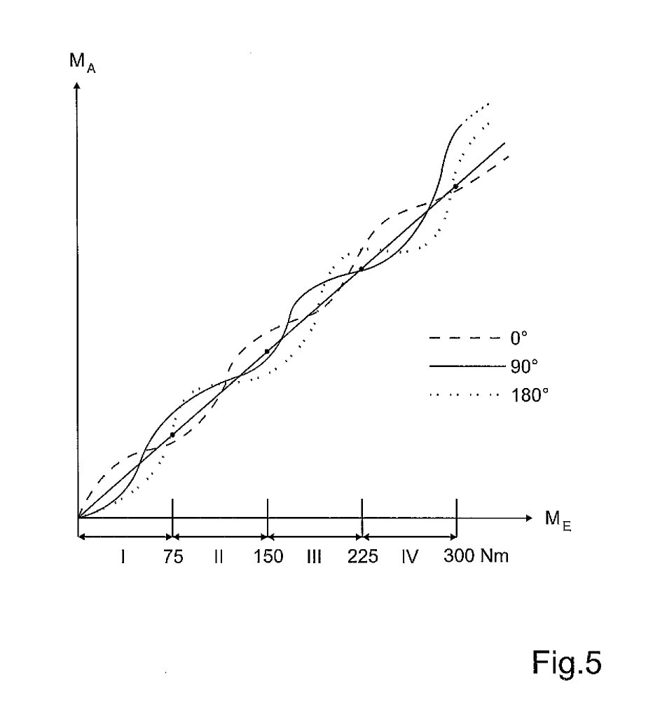

FIG. 5 shows the output torque over the input torque for explaining a variant of the method in accordance with the invention.

The apparatus shown in the drawing for producing a precise tightening torque comprises a torque multiplier, which will be referred to below and is generally known as a power multiplier 100, comprising an input shaft 101 and an output or driven shaft 102. Both the input and the output shaft respectively end in a square, on which a torque wrench 200 will act in the case of an input shaft and which will engage in a so-called “wrench socket” or simply “socket” 140 in the case of the output shaft 102. A torque is transmitted by means of the socket 142 to a screw connection (not shown). The torque multiplier 100 further comprises a generally known reaction arm 130 which prevents spinning of the torque multiplier during the steering process by impingement on a stationary object.

The torque multiplier 100 is manually actuated by a torque wrench 200. For this purpose, the torque wrench 200 comprises a handle 210. The torque wrench 200 as such is an electronic torque wrench 200 with a display 205 and an input device 220. The input device 220 is used for example for the input of data characterizing the screwing process. The setting of the torque wrench 200 occurs via a selection menu. After the selection of a menu item, the desired output torque and the desired limit values will be entered. During the application of the torque, an operator is informed visually about progress, e.g. by means of a luminous bar. Shortly before reaching the target torque, the operator can additionally be informed via an acoustic signal. After reaching the torque, there will be a preferably optical “okay” or “non-okay” display which is optionally also provided in acoustic form, and the achieved value of the torque will be stored in a data memory which is provided in the torque wrench 200 (not shown). All values are stored in the torque wrench can be transferred to a PC or laptop after completing all work and can be further evaluated there.

It is the principal idea of the invention to provide an autonomous apparatus which can make do without any additional cables, external power supply, remote input and display devices and the like. The torque wrench is operated by battery or storage battery for this purpose. Furthermore, it can be provided that torque multiplier 100 or the speed-transforming gear 110 of the torque multiplier 100 comprises an RFID transponder which cooperates with an RFID reader arranged in the torque wrench 200. In this case, the torque wrench 200 recognizes in a way the torque multiplier 100 or the gear 110 of the torque multiplier 100, and torque values can be set precisely by retrieving values which are stored in the memory of the torque wrench 200 and which were determined and stored in a previous joint calibration that will be described below in closer detail. Ratio values are stored for this purpose in the memory, which are respectively associated with the gear 110 of the torque multiplier 100. These values will be used in the computing unit provided in the torque wrench 200. The confusion of systems is prevented entirely by the combination of RFID transponder an RFID reader.

The calibration of the system consisting of torque multiplier 100 and torque wrench 200 occurs in such a way that at first the actual gear ratio is determined over the entire torque range of the torque multiplier 100. The method of this calibration will be explained below by reference to FIGS. 2 to 5. FIG. 2 schematically shows a side view of the torque multiplier 100. An input shaft 101, which ends in a square for example and on which the electronic torque wrench 200 will act, is connected with an output shaft via the gear 110, which output shaft also ends in a square 102 which engages in a wrench socket, which is also known as “power socket” 140. The power socket 140 is adjusted on the output side to the screw head or the nut of the screw connection. An input torque M_{E} is applied on the input shaft and an output torque M_{A} is applied at the output of the gear 110. The gear ratio between the input torque M_{E} and the output torque M_{A} is determined by the gear 110. This gear ratio will be determined at first, with the input torque M_{E} being determined by the electronic torque wrench 200 and the output torque M_{A} by a sensor 400 which is arranged on the output shaft. This sensor 400 is only provided during calibration. The arrangement of such a sensor 400 is not required in later operation.

The determination of the gear ratio occurs in such a way that the output shaft and therefore the output square 102 are brought to a first position which corresponds to an angle of 0° (FIG. 3b1)). The screw connection is then “tightened” in that the input torque M_{E} is applied and the output torque M_{A} is determined. This leads to a functional connection between output torque M_{A} and the input torque M_{E}, which is schematically represented in FIG. 4 by a dashed line. From the principal point of view, such a measuring series is sufficient for determining this functional connection between the output torque M_{A} and the input torque M_{E}. In this case, the interpolation curve of the function M_{A}(M_{E}) will be determined and this interpolation curve (and especially a straight interpolation line as shown in FIGS. 4 and 5) will be stored in a way as a characteristic line.

In order to further increase precision, an especially advantageous embodiment of the method in accordance with the invention provides further measuring series.

In a second measuring series, the output square 102, which means the output shaft, will be rotated by 90°, as is schematically shown on the right-hand side in FIG. 3b2), and the connection between the output torque M_{A} and the input torque M_{E} will be determined and shown in FIG. 4 as a continuous line.

Finally, the output shaft and therefore the output square 102 will be twisted in a third measuring series by a further 90° (FIG. 3b3)) and the dependence of the output torque M_{A} on the input torque M_{E} will be determined. This is shown in FIG. 4 by a dotted line. An interpolation curve, and a straight interpolation line in a first approximation, will be determined from these three lines, which will be stored in a memory 250 of the torque wrench 200 and which is representative of the dependence of the output torque M_{A} on the input torque M_{E}.

In the embodiment as shown in FIG. 4, the interpolation curve (the illustrated straight line) is formed over the entire torque range. A further increase in the position is obtained when for determining the interpolation the curve is subdivided as shown in FIG. 5 into four sub-ranges I, II, III, IV of the input torque M_{E}, and interpolation is performed in each of these partial ranges. A substantially linear progression is obtained in this case too. The number of these subdivisions can be increased further, so that in the borderline case a precise approximation of the function M_{A}(M_{E}) is possible. After completing the calibration, the sensor 400 is removed and the dependence of the output torque M_{A} on the input torque M_{E} is stored in the memory of the electronic torque wrench 200 as mentioned above and will be used during later screwing processes. The torque of screw connections can be determined in this manner in a very precise way.

The calibration over different angular ranges is necessary because all known types of gears show more or less sinusoidal fluctuations in the torque progression and therefore in the power progression as a result of the engagement conditions of the tooth flanks. This means that deviations from the theoretically calculated torque are detectable over the entire torque progression of the torque multiplier. These deviations can be taken into account and eliminated by the calibration.

1. An apparatus for producing a precise tightening torque for screw connections, comprising the combination of torque multiplier (100) and a torque wrench (200) which is adjusted to said torque multiplier and is calibrated together with said torque multiplier.

2. An apparatus according to claim 1, wherein the torque wrench (200) comprises a display (205) for displaying an input and output torque.

3. An apparatus according to claim 1, wherein the torque wrench (200) comprises an input unit (220) for the input of a torque limit value.

4. An apparatus according to claim 1, wherein the torque wrench (200) comprises a memory (250) for storing the data characterizing the torque.

5. An apparatus according to claim 4, wherein the gear ratio of the torque multiplier (100) which is determined during calibration is stored in the memory.

6. An apparatus according to claim 5, wherein the gear ratio is stored in the memory (250) as an interpolation curve of the functional connection of the output torque (M_{A}) depending on the input torque (M_{E}) of the torque multiplier (100).

7. An apparatus according to claim 1, wherein the torque multiplier (100) comprises an RFID transponder, and wherein the torque wrench (200) comprises an RFID reader, which communicate with one another and by means of which a transmission of the characteristic gear ratio (100) to the torque wrench (200) occurs.

8. A method for calibrating an apparatus for producing a precise tightening torque for screw connections according to claim 1, wherein the output torque (M_{A}) is determined depending on the input torque (M_{E}) over the entire torque progression as the gear ratio, and wherein the gear ratio (M_{A}(M_{E})) occurs on the basis of at least one average value obtained over the entire torque range.

9. A method according to claim 8, wherein the average value is determined by forming an interpolation curve, especially a straight interpolation line.

10. A method according to claim 8, wherein the gear ratio is determined at several gear engagement angles (0°, 90°, 180°).

11. A method according to claim 10, wherein the actual gear ratio is determined at first over the entire predeterminable torque range, and wherein thereafter an output shaft of the torque multiplier (100) will be further rotated about respectively predeterminable angles, especially twice about 90°, and the gear ratio over the entire torque range will be determined in this process and a mean gear ratio will be calculated therefrom, which will be stored in the memory (250) of the torque wrench (200).
